(19) United States
(12) Patent Application Publication
(10) Pub. No.: US 2007/0035665 A1
(43) Pub. Date: Feb. 15, 2007

(54) Method and system for communicating lighting effects with additional layering in a video stream

(75) Inventors: Rajendra Kumar Khare, Bangalore (IN); Brajabandhu Mishra, Orissa (IN); Sandeep Kumar Relan, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/202,224

(22) Filed: Aug. 12, 2005

(51) Int. Cl. H04N 9/74

(52) U.S. Cl. 348/586; 348/589

(57) ABSTRACT

A video streaming system that supports an additional layer for lighting effects in video streams transmitted from a broadcast studio such that a video layer with special effects is transmitted separately from the video stream by a transmitter makes it possible to provide for user selectable video lighting effects. A corresponding user box/consumer box capable of using the additional layers of video effects makes it possible to display such lighting effects on the video stream. The consumer box activates at least one effects form the plurality of effects on the input video stream, according to the user's selections and preferences. In one embodiment, a mixing unit makes it possible to mix the video streams with the special effects sent in the additional layers and the output of the mixing unit is configured to be displayed on a display unit.

### BACKGROUND OF THE INVENTION

1. Field of the Invention:

This invention is related to employing additional data layers for communicating lighting effects for video streams, that enables the activation of special effects on the video stream transmitted from a studio, incorporating user selections.

2. Description of the Related Art:

Audio devices have been used by individuals to create music during a live performances wherein the user can have different effects on the audio signal, so that output is made more pleasing. These effects work, for example, by introducing bass and treble signals and by changing gain of different filters used in an equalizer.

Systems are available in the market which enable users to play back video streams, live or pre-programmed. However, the features of these audio devices have not been applied to a video environment. In a conventional video broadcast, only video signals are transmitted from the studio, while controllable effects are not transmitted, so that a viewer can view the video only as it is transmitted from the studio. Even when some special effects are transmitted along with the input video stream effects, these effects are not according to the user's selections. These are very likely to have been predefined in the video stream itself. Thus, user control over these video streams is limited or non existent.

Techniques to manipulate digital imagery to generate particular effects for movie and television have revolutionized the film industry. Developers and artists, using a computer as a digital manipulation tool, can now generate special effects on projects of various scales, ranging from very high budget film to low-budget independent films to television movies to movie shorts from home video collections.

Audio visual lighting and special effects add flair and drama to a programmed video event, such as in broadcast television. Lasers lights show pyrotechnics and other special effects used effectively at a party or small event can make the guest feel they are at a concert or large-scale gala. These special effects cannot yet be effectively used by the user for entertainment purposes and to explore their creativity while editing videos. In movies, the film makers use sophisticated techniques to accomplish more advanced effects. For example, computer generated backgrounds can be superimposed on to the films. Such techniques require expensive equipment, and are not part of a commercial mass market product.

Additionally, there are no existing systems comparable to an audio effects system, which enable the activation of audio effects on the input audio stream for creating an environment.

### BRIEF DESCRIPTION OF THE DRAWINGS

For the present invention to be easily understood and readily practiced, preferred embodiments will now be described, for purposes of illustration and not limitation, in conjunction with the following:

FIG. 1 is a block diagram illustrating one embodiment of a system that incorporates additional layers for lighting effects for video streams in accordance with the present invention;

FIG. 2 is a block diagram of an exemplary user/consumer box that is capable of receiving and using the additional layers of lighting effects send in a video stream, according to an embodiment of the invention;

FIG. 3 is a block diagram of an additional embodiment of the invention; and

FIG. 4 is a block diagram of an alternative embodiment of the invention.

### DETAILED DESCRIPTION OF THE PREFERRED EMBODIMENT(S)

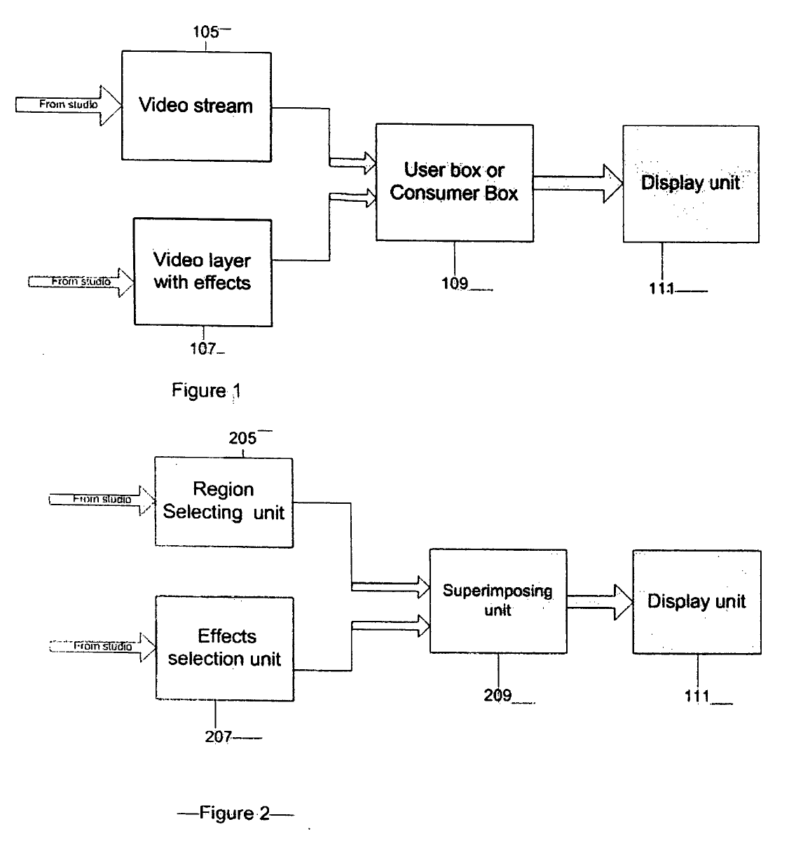

FIG. 1 is a schematic block diagram illustrating one embodiment of a system that incorporates additional layers for lighting effects for video streams in accordance with the present invention. The system utilizes a video stream 105 transmitted from the studio, video layers with effects transmitted separately from the studio 107, providing input to a user box or consumer box 109 that is capable of using the additional layers of lighting effects. The output of consumer box is provided to the display unit 111, which displays the video stream with some effects on the regions defined by the user.

In general, the present invention relates to superimposing effects on the video stream transmitted from a broadcast studio according that incorporates a user's selection of lighting effects. These effects are transmitted as separate layers from the studio. Although the following discusses aspects of the invention in terms of additional layer for lighting effects on a video stream system, it should be clear that the following also applies to other types of systems.

The additional lighting effects for a video stream can be used in a number of ways, including spot light effects used in film industries. It can be used for highlighting certain features on the incoming video stream. Computer generated background may also be superimposed on the video stream along with the lighting effects.

In film and video industries, for example, different special effects techniques are combined to create an image. A number of special effects techniques are used to build a complete 3D computer model of the computer generated scene and these special effects need to be communicated to a display unit. The present invention provides for such communication in broadcast networks and multi-cast networks through the use of additional layers in a video stream.

One example might be highlighting multiple moving objects in a scene. The background can be static and two cars, for example, may be moving. By applying effects on these moving cars, one of them may be highlighted, or we can see these two cars at different resolution, one at low resolution and other at high resolution.

Another example might be highlighting dynamic activity of one player in a game of cricket or in a game of football in the live telecast of the match. In a live telecast of a match, numbers of players are present. Among the number of players, we can track the dynamic activity of one or more players according to a user's preferences and introduce the effects on these selected players, so that the selected region appears different than the other regions in video, so that the viewer is attracted towards that region.

In certain embodiments of the invention, the display unit 111 can be placed in visual proximity to a viewer. Watching the scene on the display, which could be, for example, a live cricket match or football match, the user can define the area of interest on which some special effects are applied.

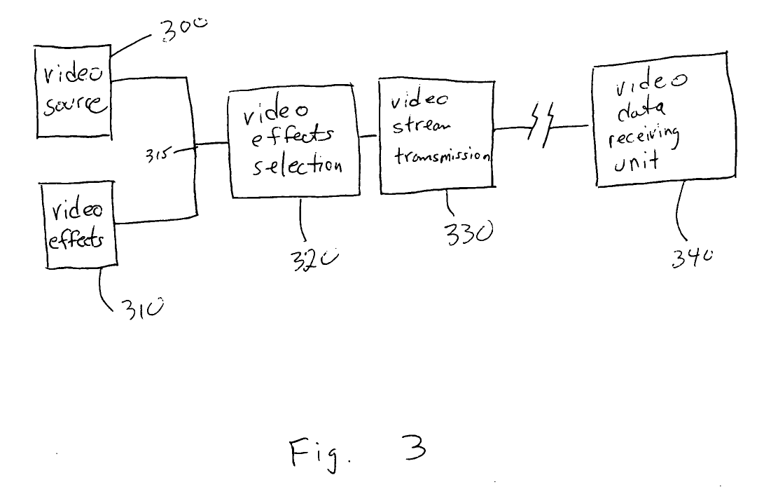

FIG. 2 illustrates an example of one embodiment of consumer box or user box 109. It should be noted the elements illustrated in FIG. 2 could, in other embodiments, be implemented as separate elements, or could be combined—i.e. the selecting unit and region tracking unit could be combined in to a single unit.

In FIG. 2, a region-selecting unit receives the signal from the video stream transmitted from the studio. For operation in real time environment, a user can select the regions of interest from the video sources while the video is being fed to the selecting unit. Utilizing such conventional input and control devices such as the keyboard, mouse, wireless pointing device, a tablet, a touch-screen, etc. a user can control the selecting unit. The appropriate regions of interest are then selected based upon appropriate locating methods, such as coordinates in an area of a screen, selection of a predefined objects, whether it be dynamic or static, based upon predefined characteristics of the objects, etc. Software or hardware can be configured within the selecting unit 205 to support such selections by a user. In addition, such hardware or software can be configured to track or to follow a dynamic region of interest, such as talking person, a moving person, a player on a tennis court, a player in cricket or football game, moving objects such as a racing car, or a virtually any other moving device.

In using the term layers, video data and video effects are combined to form separate layers of a video stream. For example, different types of packets can be placed in the final video stream which is transmitted or which is received by various embodiments of the invention. For example, packets containing video data may have a particular identifier or identification field in the packet header to distinguish the video data packets from, for example, video effect packets. In some embodiments it may be expedient to introduce video effect packets in between the video data packets in a data stream. This can enable efficient changes in video effects, and provide unique opportunities for synchronization.

As will be discussed below, various types of effects, and selected regions of interest can be identified in the data stream by particular indices associated with particular properties, or by other indicia.

Additionally, the video data and the video effect data can, in some embodiments, be transmitted as separate streams, rather than specific layers. When implemented as separate streams, appropriate synchronization is necessary to ensure that the appropriate effect data corresponds with the appropriate video data.

The selecting unit can also select a plurality of regions of interest in the incoming video stream. The special effects selecting unit 207 receives the signal from the studio. For operation in a real time environment, a user can select at least one effect that is superimposed on the regions of interest of the input video stream. Superimposing unit 209 can be configured to superimpose special effects transmitted from the studio on the incoming video stream. Examples of such additional layers for lighting effects might be spot light effects, zooming effects, warping effects, fading effects, fast/slow replay, etc. It may also include viewing the region of interest at different resolution or at different scale. Through the use of image tracking software provided in the selecting unit 205, the moving image can be tracked from the incoming video stream. The region selecting unit can be configured to select a plurality of regions of interest.

The video stream transmitted from the studio 105, in addition to the images discussed above, might also include one or more motion picture video, martial art video, video game images, etc. Various video recordings can be stored in a video library and transmitted from the studio and accessed by the user for various applications. The superimposing unit 209 is configured to superimpose the special effects on the selected regions of interest on the video that can be preset by the user. It would also be possible to utilize an image-tracking unit 205 on the inputs video stream 105, to enable real time superimposition of effects on the video source. It is possible to provide video stream from a second and third studio (or broadcast channel), and image tracking and effects selection can be configured as necessary.

Superimposition of effects on the video stream 105 can be done by selecting the region of interest, for example, with a keyboard, mouse, or wireless remote control unit. Selection of the image can be done within selecting unit 205, either manually or automatically. Another embodiment is one wherein the video stream transmitted from the studio is prerecorded and region of interest on which the effects are selected within selecting unit 205. These effects are selected from the effects selecting unit 207, which receives the signal from the video layers, transmitted from the studio. In another embodiment, the video stream could be live feeds from the transmitter, where certain aspects of each live feed are selected by the selecting unit 205 according to the user, user selects the effects from the effects selecting unit 207, and these effects are activated on the regions selected, and ultimately displayed on a display unit 113. It is noted that for certain video broadcast implementations, the output of the invention is a transmitted video signal with effects. Once the region of interest is selected with the selecting unit, the region of interest can be contrasted with the non-selected areas by a change in brightness, a change in resolution, a change in color, or any other change which would be perceived by the human eye and by the hardware. After the region of interest is selected, the user is provided with an option to select from one or more of a plurality of effects. These options may be automatically presented after the region of interest has been identified by presenting a menu or legend on the screen, than allowing the user to select the appropriate effect. Alternatively, the user may be able to selectively create the menu or select the particular effect by actuating a switch on the pointing device. The menu provides access to the various effects which are layered into the video screen, but which have no effect on the video data until they are selected to be utilized in a region of interest.

In another embodiment of the invention, the selecting unit 205 or superimposing unit 209 can be configured with a resolution-adjusting capability, such that in situations where the input video stream 105 could and the video layer with effects 107 are in different spectral bands, or have different resolutions, the resolution can be adjusted as necessary. In some implementations, it might be desirable to adjust the resolution of the incoming video stream so that an illusion of 3D images can be created. Various phase shifting implementations can be utilized, or convention 3D utilizing well known 3D-glasses could be implemented.

In another embodiment of invention, the consumer box/user box 109 and display unit 111 might be configured with a resolution-adjusting capability, so that output of the superimposing unit can be displayed at different resolution. The display unit might display different regions of the video stream at different resolution.

An important feature of this invention is that the various effects which can be applied to the selected regions of interest are not based upon special data or special software which resides in the region selecting unit or the effects selection unit. While the effects are selected by the region selecting unit or the effects selection unit, the data regarding the selectable effect is provided as part of the video stream as transmitted from either a studio, a broadcasting station, or other transmission source. In one embodiment, the region selecting unit and the effects selection unit can be disposed within a conventional computer, with the menu information, effects selection, and other data being part of the data being transmitted from the transmission source.

The region selecting unit, effects selection unit, and superimposing unit would, in such an embodiment, be configured to have appropriate memory to store data regarding the selected region of interest, and to store data regarding the effects which are to be selected, and to render the data on the display. Such memory may be configured as cache memory if appropriate, or any other type of random-access memory would meet the speed and storage requirements which would be applicable for the particular application.

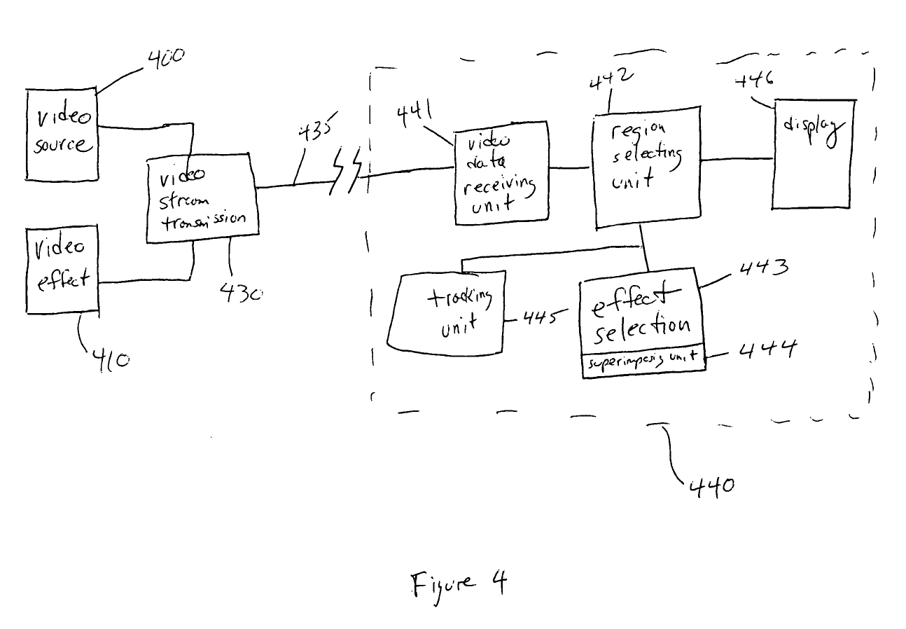

Referring to FIG. 3, an embodiment of the invention is illustrated wherein video effects selection occurs prior to transmission of the video stream. Video source 300 provides video data, from a source such as a live feed from a sports event, a live feed from another source, or prerecorded video data. Video effects unit 310 provides video data which is added as an additional layer to the data from the video source, thereby providing video stream 315. Video effects selection unit 320 can include elements such as a display, a pointing device such as a keyboard, mouse, tablet, etc., and has appropriate cache memory for storing segments of video data and viewing the video data on the display. The video effects selection unit enables a user to select video effects from video stream 315, and apply these effects to selected regions of interest of the video data. As discussed previously, such effects may include highlighting, low lighting, spot light effects, zooming effects, warping effects, fading effects, or virtually any type of visual effect on the video data. After the appropriate effects have been applied by the user, the modified video data is output by video stream transmission unit 330. The video stream may be transmitted via cable, internet, wireless, satellite transmission, or any appropriate medium for transmitting electronic data. After transmission, the video data can be received by a video data receiving unit 340, which could be a personal computer, PDA, lap top computer, or virtually any portable or non-portable data receiving device.

FIG. 4 illustrates another embodiment of the invention, wherein selection of video effects and regions of interest is performed on the receiving side. In this embodiment, video source 400 provides video data from a video source, in a manner similar to video source 300. Video effects unit 410 can store and apply a series of selectable video effects, which can be selectably applied as a layer to the video data from video source 400. Video stream transmission unit 430 transmits the video data and the selectable video effect data as a single video stream. The video stream can be received by video effects unit 440; it should be noted that video effects unit 440 is illustrated in this embodiment as a single unit, but the elements of video selection which are illustrated herein may be implemented as separate discrete elements. Video effects unit 440 may include video data receiving unit 441, which receives video stream 435 from video stream transmission unit 430. From the video data receiving unit, region selecting unit 442 receives video stream 435, which includes a video data layer and a video effects layer. Region selection unit 442 can enable a user to select a region of interest from the video data. Tracking unit 445, which can be a part of region selecting unit 442, can be used to track the selected region of interest. A user can select one or more of a plurality of video effects from the video effect layer of video stream 435. As discussed previously, video effect database 410 provides a plurality of video effects as an additional layer on the video stream. A user can select video effects which can be applied to the selected region of interest from region selecting unit 442, or may select effects to apply to other regions of the video data, other than the selected region of interest. Effect selection unit 443, or video effects unit 440, can include superimposing unit 444 which can superimpose the selected video effects on the appropriate sections of the video data. Superimposing unit 444 may, in some embodiments, be a separate unit. The modified video data is then output on display 446.

In other embodiments, it is possible for the region of interest and menu information to be handled locally, for example at video data receiving unit 340, but wherein the video effect data is provided locally rather than being transmitted as a different layer in the data stream. This would enable local customization without special transmission of a separate layer.

It is worthy to note that this type of region selection and application of video effects can be done in realtime as the video stream comes into the video effects unit, and the modified data can immediately be shown on the display. In the alternative, the data can be modified and stored in a cache memory for a slight delay from the time of receipt by the video data receiving unit to the time that the modified data is displayed on display 446. In other embodiments, the data may be stored in a storage unit such as digital video disc, random access memory, magnetic or digital tape, or other appropriate storage unit for display at a later time.

While the present invention has been described with reference to certain embodiments, it will be understood by those skilled in the art that various changes may be made and equivalent may be substituted without departing from the scope of the present invention. In addition, any modifications may be made to adapt a particular situation or material to the teaching of the present invention without departing from its scope. Therefore, it is intended that the present invention not be limited to the particular embodiment disclosed, but that the present invention will include all embodiments falling within the scope of the appended claims.

The above-discussed embodiments of the invention are discussed for illustrative purposes only. It would be understood to a person of skill in the art that other embodiments and other configurations are possible, while still maintaining the spirit and scope of the invention. For a proper determination of the scope of the present invention, reference should be made to the appended claims.

We claim:

1. A video broadcasting system, said system comprising:
a video data receiving unit for receiving video data from a video source;
a video stream transmission unit for transmitting the video data as a video stream;
a video effects database for storing and transmitting selected video effects as a layer on the video stream;
wherein the video stream is configured whereby selected video effects are superimposed on the video data.

2. A video broadcasting system as recited in claim 1, wherein said video effects data includes selection data which enables a user to select video effects.

3. A video effects unit for applying selectable video effects on a video stream, said unit comprising:
a data receiving unit for receiving a video stream containing video data from a video source;
a region selecting unit for selecting a region of interest from the video data;
an effects selection unit for selecting effects from a layer of said video stream, wherein said effects are configured to be applied to the video data;
a superimposing unit for applying selected effects from the effects selection unit to one of the selected region of interest and other regions of the video data.

4. The video effects unit as recited in claim 3, further comprising a display for displaying the video data.

5. The video effects unit as recited in claim 3, further comprising a tracking unit for tracking the selected region of interest.

6. A video broadcasting system as recited in claim 1, wherein the transmitting unit transmits a live video feed from an image capture device.

7. The video broadcasting system as recited in claim 1, wherein the transmitting unit transmits a recorded video stream.

8. The video broadcasting system as recited in claim 1, wherein the transmitting unit transmits video data from a video game.

9. The video broadcasting system as recited in claim 1, wherein the transmitting unit transmits a broadcast of a sporting event.

10. A video broadcasting system as recited in claim 1, wherein the video effects transmission unit includes a video effects selection unit for selecting and applying video effects from the video effects data.

11. A video broadcasting system as recited in claim 1, wherein said video data receiving unit includes a video effects selection unit for selecting and applying video effects from the video effects data.

12. A video broadcasting system as recited in claim 1, wherein said video stream transmission unit transmits video data as a first layer and video effect data as a second layer on said video stream.

13. A video broadcasting system as recited in claim 12, wherein said video data comprises data packets having a first identifier, and wherein said video effect data comprises packets having a second identifier.

14. A video broadcasting system as recited in claim 13, wherein some video effect packets are disposed between the video data packets in the video stream.

15. A video broadcasting system, said system comprising:
video data receiving means for receiving video data from a video source;
video stream transmission means for transmitting video data as a video stream from the video source;
video effects storage means for storing and transmitting selected video effects as a layer on the video stream,
wherein the video stream is configured such that selected video effects are superimposed on the video data.

16. A video effects unit for applying selectable video effects on a video stream, said video effects unit comprising:
data receiving means for receiving a video stream containing video data from a video source;
region selecting means for selecting a region of interest from the video data;
effects selection means for selecting effects from a layer of the video stream, wherein said effects are configured to be applied to the video data;
superimposing means for applying selected effects from the effects selection means to one of the selected region of interest and other regions of the video data.

17. The video effects unit as recited in claim 16, further comprising display means for displaying the video data.

18. The video effects unit as recited in claim 16, further comprising tracking means for tracking the selected region of interest.

19. A video transmission system, said system comprising:
a video data interface for receiving video data from a video source;
a video effects database for storing selected video effects, wherein said selected video effects are configured to be applied to the video data;
selection means for selecting and applying selected video effects from the video effects database, and applying the selected video effects to selected regions of interest of the video data;
output means for outputting the video stream comprising the video data and the selected video effects.
